(19) United States
(12) Patent Application Publication
(10) Pub. No.: US 2025/0282917 A1
(43) Pub. Date: Sep. 11, 2025

(54) THE USE OF HYDROPHILIC AND HYDROPHOBIC DEEP EUTECTIC SOLUTIONS AS PLASTICIZERS

(71) Applicant: BURSA TEKNIK ÜNIVERSITESI, Yildirim, Bursa (TR)

(72) Inventors: Adnan Fatih DAGDELEN, Yildirim, Bursa (TR); Furkan Türker SARICAOGLU, Yildirim, Bursa (TR); Fatma Tuba KIRAÇ DEMIREL, Yildirim, Bursa (TR); Ömer Yunus GÜMÜS, Yildirim, Bursa (TR)

(21) Appl. No.: 18/863,825

(22) PCT Filed: Apr. 12, 2023
(86) PCT No.: PCT/TR2023/050342

§ 371 Date: Nov. 7, 2024

(30) Foreign Application Priority Data
May 10, 2022 (TR) 2022/007589

(51) Int. Cl. C08J 3/18; C08J 3/215; C08J 5/18

(52) U.S. Cl. CPC C08J 3/18; C08J 3/215; C08J 5/18; C08J 2367/04

(57) ABSTRACT

Disclosed is a deep eutectic solvent production method, which involves the selection of compounds that receive hydrogen bonds and give hydrogen bonds in such a way that the deep eutectic solutions desired to be used in the application of wet or dry plasticization method to polymers, and a plastic manufactured in accordance with this production method.

### TECHNICAL FIELD

The invention relates to the use of deep eutectic solutions of hydrophilic or hydrophobic character synthesized from components of natural origin as plasticizers in polymers produced from synthetic substances of natural or petroleum origin.

### PRIOR ART

Plasticizers are an important class of low- or high-density non-volatile compounds that are most commonly used as additives in the polymer industries. The primary role of such substances is to improve the flexibility and processability of polymers by reducing the glassy transition temperature (Tg). The IUPAC (International Union of Pure and Applied Chemistry council has defined a plasticizer as “a substance or material that is joined to a material (usually a plastic or elastomer) to increase its flexibility, workability or extensibility”. These substances reduce the deformation stress, hardness, density, viscosity and electrostatic charge of a polymer, while at the same time increasing the polymer chain elasticity, fracture resistance and dielectric constant. In addition to other physical properties, it also affects other properties such as the degree of crystallinity, optical clarity, electrical conductivity, fire behavior and resistance to biological degradation.

According to the data of 2021, plasticizers are produced about 8 million tons worldwide. These substances, which have an annual growth rate of 4%, are used in the production of consumer products (such as toys, shoes), construction (floor and wall coverings), electricity (cables), packaging, transportation (wheels), furniture and medical products. About 90% of the plasticizers produced are also used in polyvinyl chloride (PVC). Apart from This the plasticizer can be used in many petroleum based plastics (such as PAN, PU, PA, PC, PET, PE, PMMA, PP, PS, PVDF, PVDC) according to the field of use. Plasticizers having linear or cyclic carbon chains (14-40 carbon) and high boiling point are classified as internal and external effective according to the plasticization mechanism, according to the field of use; they are classified as general purpose, low volatility, low temperature, fast melting and special, according to molecular weight; they can be classified as monomeric (300-600 g/mol). Plasticizers that can be produced from petroleum derivatives and renewable sources are produced in more than 100 varieties in the world, but only about 50 of them are of commercial importance. Phthalates take the largest share in plasticizers with about 75%. For an effective plasticization, various parameters are checked, including polarity, hydrogen bond, dielectric constant, thermal strength and Decolonization parameters, as well as compatibility between the plasticizer and the polymer. Since plasticizers cannot covalently bind to the polymer chain and to each other in the plastic in which they are used, they can separate from the structure over time and cause negative consequences for human health and the environment. Especially in varieties with low density, this risk is much higher. Since restrictions have been imposed on many plasticizers with international standards, the demand for safer and non-toxic plasticizers has increased.

Today, it is important to develop new polymers and polymer additives with low toxicity and low migration properties produced from renewable and biodegradable sources that have the potential to reduce the use of traditional petroleum-derived plastic products. For this purpose, plasticizers are produced by reducing natural polymers (such as vegetable oils, starch) to fatty acids or alcohols and then undergoing chemical modification (Vieira et al., 2011). Polyols such as glycerol, sorbitol, on the other hand, have a positive effect as a plasticizer on polymers of mostly natural origin. However, in the films where polyols are used, they cause an increase in hydrophilic property, a weakening of mechanical and water vapor permeability (Lopez et al., 2008; Gönenç, 2012). In this context, although the technological properties of traditional plasticizers used in polymer processing are very good, it is not appropriate to use them in biodegradable polymers due to the lack of biodegradable properties of most of them. In addition, the fact that it is not yet technologically possible to completely replace synthetic plasticizers with natural-based plasticizers shows that there is a need for further research and development in this area.

Green Chemistry is a concept defined as “the design of chemical products and processes to reduce or eliminate the use and formation of hazardous substances” and has 12 basic principles to achieve international sustainability goals. The most important part of these principles is the development of a new generation of solution alternatives that are environmentally friendly and can be used in many chemical processes instead of the solutions that are traditionally used and whose toxic effects are known. Although the development of solvent-free processes is the most ideal, solvents are almost inevitably used due to their important roles in dissolving solids, mass and heat transfer, affecting viscosity, and separation-purification steps. In the development and selection of these solvents, the criteria of being cheap, non-toxic, biodegradable, reusable and sustainable are taken into account. However, it is not always very easy to provide all of these features together Decently. These Liquids, called green solutions, can be classified as supercritical fluid (SCF), ionic liquid (IL), deep eutectic solvent (DES), gas-expanded liquids (gas-expanded liquids), LIQUID polymers (liquid polymers) and switchable solvents (switchable solvents). Those who have received great attention in recent years are mostly IL and DES. IL and DES, which are used as alternatives to traditional solvents in many fields, especially synthesis, catalysis, solvent, additive and extraction, have many common properties. The terms low transition temperature mixtures (LTTM) or low melting temperature mixtures (LMM) can also be used in their definition, since DES, which do not contain the negative properties of IL, are generally mixtures with a low melting temperature. Physicochemical properties of DES (density, viscosity, refractive index, conductivity, surface tension, chemical inertness, etc.) are very close to the properties of commonly used IL's, and although most DES's are made of choline chloride (CHCl) as an ionic species, DES's are not considered IL because they can also be obtained from non-ionic species. DES can be prepared by simply mixing 2 or 3 safe components as hydrogen bond acceptor (HBA) and hydrogen bond transmitter (HBD). The expression DES was first used by Abbott et al in 2003. the feeling is classified into five groups along with the developments. These:
Type I: Combination of organic salts and metal salts (e.g.: CHCl+ZnC₁₂)
Type II: Combination of organic salts and metal hydrates (e.g.: CHCl+COC₁₂·6H₂O)
Type III: A mixture of organic salts and a compound with hydrogen bond donors (e.g.: HCl+urea)
Type IV: A combination of metal chlorides and a compound with hydrogen bond donors (e.g.: ZnCl₂+urea)
Type V (new): A combination of non-ionic HBAs and HBDs (phenols) (e.g.: Menthol+Thymol)

It is possible to prepare DES with various physical and chemical properties with many kinds of HBA and HBD components. In its preparation; mixing, heating and grinding are the most commonly used methods, and in addition, methods such as evaporation, freeze-drying, extrusion, ultrasound and microwave can also be used.

HBAs mainly contain quaternary ammonium or phosphonium salts, while the most common HBDs are amides, alcohols and acids. The most popular ingredient used as HBA is choline chloride (CHCl), an inexpensive, biodegradable, highly hygroscopic, low toxicity, easily synthesizable from biomass or fossil reserves, a quaternary ammonium chloride salt classified by the FDA as GRAS and also called vitamin B4. Due to their hydrogen bonding capabilities, the majority of DES are hydrophilic and dissolve quite easily in an aqueous environment. Hydrophobic DES (HBDES), on the other hand, have a history of less than 10 years and are mostly used for extraction purposes. In the preparation of HBDES, various initial compounds such as long-chain quaternary ammonium halides, menthol, thymol, long alkyl chain fatty acids, long alkyl chain alcohols and carboxylic acids can be used to produce HBDES with different physicochemical properties. Hydrophilic DES (HFDES) and HBDES are prepared in the same way and by mixing the components used in a certain molar ratio. This ratio between HBA and HBD is usually selected as a 1:2 molar, this ratio can be up to 1:8 to achieve ideal properties. When developing a new DES solution, an initial molar ratio of 1:1 is usually the most commonly used. DES, which can be used as an alternative to traditional solvents in many fields, especially synthesis, catalysis, solvent, additive and extraction, can be used in the production of flexible polymeric materials as plasticizers. There are many studies aimed at its use in polymers obtained from natural sources such as pectin, chitosan, starch and cellulose, especially as a natural plasticizer. In these studies, DES has a hydrophilic character and has been used as a plasticizer in hydrophilic natural polymers. Again, in these studies, in addition to giving hydrophilic DES positive properties in hydrophilic polymers of natural origin, it is also stated that each DES can exhibit different behavior and cause weakening in some properties of packaging films (such as mechanical, barrier, thermal). In addition, it is stated that DES can be used as a plasticizer in the polymer structure, as well as as a modifier, crosslinker and harmonizer.

With the environmental pollution and climate changes, the increasing interest and demand for products made from natural renewable sources and decomposing into environmentally friendly components, and the future of strict legal regulations on a global scale, green approaches to be made in this direction have gained importance. With the invention, it is thought that hydrophilic and hydrophobic DES will fill an important gap in this field by providing a natural-based alternative to traditional synthetic plasticizers in all polymers, especially hydrophobic polymers. Although there are studies on the use of hydrophilic DES in hydrophilic polymers as a plasticizer as a result of extensive literature research, no research, patents, etc. studies on the use of hydrophilic DES and hydrophobic DES as plasticizers in hydrophobic polymers have been found.

In the preliminary patent research conducted, the following documents were encountered.

There is optimization information about hydrophilic polymer materials and solutions formed with DES in the method steps mentioned in the PCT document WO2020234231A1 reference number and the use of these solutions in plasticization reactions.

In the US document US20200199305A1 reference number, there are method steps involving the use of DES and ionic solvents to improve the mechanical properties of a thermoplastic material.

In the US document U.S. Pat. No. 10,323,116B2 application number, there are method steps involving the use of DES and ionic liquid for use in the formation of polyurethane foam. Although there is no mention of a technical feature caused by the structural hydrophilicity of polyurethane, there is no information about its impact on the environment.

As a result, all the problems mentioned above have made it mandatory to make an innovation in the relevant field.

### THE PURPOSE OF THE INVENTION

The current invention aims to eliminate the above-mentioned problems and make a technical innovation in the relevant field.

The main objective of the invention is to develop hydrophilic deep eutectic solutions (HFDES) and hydrophobic deep eutectic solutions (HBDES) with properties that can be used as plasticizers in hydrophobic polymers.

Another purpose of the invention is to provide a field of use for DES solutions consisting of food-quality natural materials, which are characterized as GRAS (generally recognized as safe).

### BRIEF DESCRIPTION OF THE INVENTION

In order to realize all the purposes mentioned above and which will emerge from the detailed description below, the current invention is a hydrophilic/hydrophobic deep eutectic solution production method for use in the plasticization of polymers comprising that; it includes the following processing steps before the dry or wet plasticization method steps,
a) Mixing of hydrogen bond acceptor substance (HBA) and hydrogen bond donor substance (HBD) at a temperature of 25° C.-100° C. for 1-24 hours so that the HBA/HBD molar concentrations are in the ratio of 1-5/1-8,
b) Control of crystallization by keeping at room temperature for 24-72 hours,
c) Drying of deep eutectic solutions (DES) without crystallization for 24-72 hours at a temperature of 40° C.-70° C.

A preferred embodiment of the invention is that, process step a includes one of the individuals or combinations selected from the group consisting of grinding, evaporation, freeze drying, extrusion, ultrasound and microwave processes along with the mentioned mixing process.

An another preferred embodiment of the invention is that, the HBA mentioned is choline chloride.

A preferred embodiment of the invention is that, the mentioned HBD is an individual or combinations selected from a group consisting of acids, nitrogenous compounds, polyols, sugars and phenols.

A preferred embodiment of the invention is that the solution obtained by the production method mentioned in any of the claims 1-4 is hydrophilic deep eutectic solution (HFDES).

An another preferred embodiment of the invention is that, the HBA mentioned is an individual selected from a group consisting of quaternary ammonium halides, terpenes, Atropine, Proline, Alanine, Lysine, dodecanoic acid.

An alternative embodiment of the invention is that, the mentioned HBD is an individual or combinations selected from a group consisting of fatty acids, acids, terpenes, Phenol, Atropine, 1-tetradecanol, 1,2-decandiol, 1-naptol, proline, arginine, ethylene glycol, glycerol.

The invention is also the solution obtained by the production method mentioned in either 1, 2, 6 or 7 is a hydrophobic deep eutetic solution (HBDES).

A preferred embodiment of the invention is that, the mentioned wet plasticization method includes the steps;
a) Weighing polymer substance (P), deep eutectic solution (DES) and solvent(S) in a glass container in a ratio of; Polymer material (P)/Solvent(S) ratio: 1-30/100-mass/volume and DES/Polymer material (P) ratio: 1-50/100-mass/mass,
b) Dissolving the polymer substances (P) in an appropriate solvent(S) by mixing for 1-24 hours until a homogeneous mixture is formed at a temperature lower than 25° C., so that the boiling point of the solvent is below, and the formation of a solution by adding a deep eutectic solution (DES) as a plasticizer (1) occurs,
c) Performing the homogenization (2) process by mixing the polymer substance (P), solvent(S) and DES mixture for 1-24 hours until a homogeneous mixture is formed at a temperature of 25° C., so that the boiling point of the solvent(S) is below the boiling point of the solvent(S),
d) Providing gas removal by keeping the mixture (3) formed,
e) Casting (4) process,
f) Solvent removal (5) by keeping the solvent(S) at a minimum temperature of 25° C. for a maximum of 48 hours,
g) Peeling (6),

A preferred embodiment of the invention is that, the solvent(S) mentioned is xylene, toluene, benzene, dichloromethane, chloroform, carbon tetrachloride, tetrahydrofuran, dimethylformamide, dimethylsulfoxide, acetone or methanol.

The invention is a plastic wet production method that, the application of the casting (4) process mentioned in the e process step to a glass, metal or polytetrafluoroethylene (PTFE) surface.

A preferred embodiment of the invention is that, the mentioned dry plasticization method;
Mechanical mixing of polymers with deep eutectic solutions at DES/Polymer: 1-50/100-mass/mass ratio, at a temperature of 25° C. and in a period of 1-60 minutes,
Interaction of the prepared mixture with each other by adding from the hopper (7), rotating the screw pitches (12) steps located on the extrusion screw (9) in the barrel (11), moving forward to be affected by the heat given by the heaters (10) by the rotation of the screw pitches (12),
The polymer compressed from the part of the shaping die (13) and subjected to the plasticization process comes out in a manner determined according to the structure of the extrudate (14),

The invention is also a plastic material of polymer which is produced by a method according to any of the methods above.

### BRIEF DESCRIPTION OF THE SHAPES

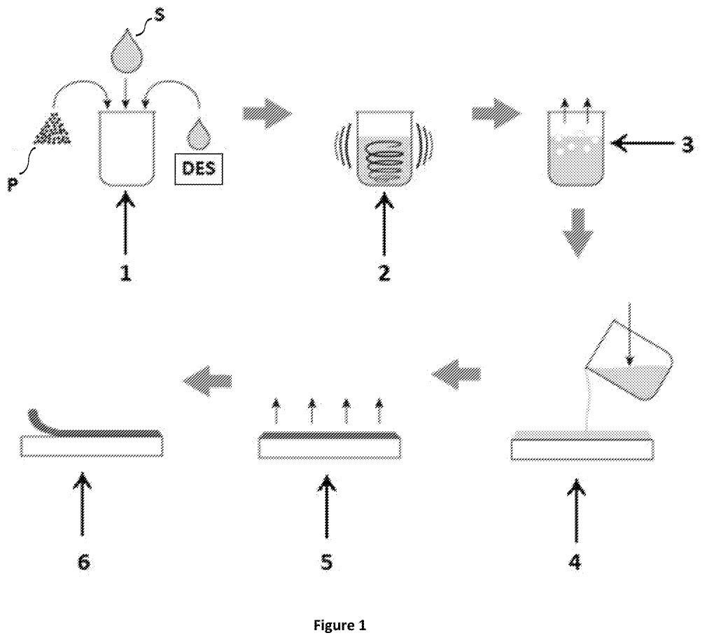

FIG. 1 shows the stages of polymer film production by wet method.

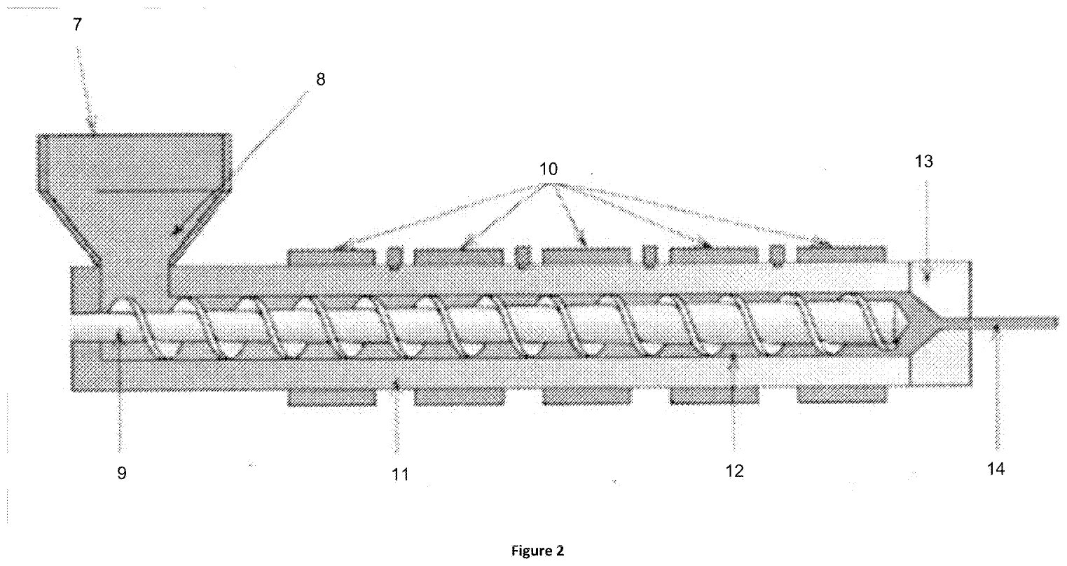

The sectional view of the extrusion system is given in FIG. 2.

The drawings do not necessarily need to be scaled up, and details that are not necessary to understand the current invention may have been omitted. Furthermore, elements that are at least largely identical, or at least have largely identical functions, are indicated by the same number.

### DESCRIPTION OF THE REFERENCE NUMBERS IN THE FIGS

1. Solution formation
2. Homogenization
3. Gas removal
4. Casting
5. Solvent removal
6. Peel
7. Hopper
8. Plastic pellet
9. Extrusion screw
10. Heater
11. Barrel
12. Screw pitches
13. Shaping die
14. Extrudate
P. Polymer material
S. Solvent

### DETAILED DESCRIPTION OF THE INVENTION

In this detailed explanation, the subject of the invention “The Use of Hydrophilic And Hydrophobic Deep Eutectic Solutions as Plasticizers in Polymers” is explained only with examples that will not have any limiting effect in order to understand the subject better.

The most important part of the protection of the invention is the creation of hydrophilic and hydrophobic deep eutectic solutions (DES). In this context; The hydrogen bond acceptor/hydrogen bond donor (HBA/HBD) molar concentrations to be selected for DES production are weighed with ±1 mg accuracy from the HBA/HBD components in such a way that the ratios are 1-5/1-8, and then mixed for 1-24 hours until a clear liquid solution is formed at a temperature between 25-100° C. by methods such as mixing, heating, grinding, evaporation, freeze drying, extrusion, ultrasound and microwave, and the recrystallization is checked by holding at room temperature for 24-72 hours, and crystallization is controlled by crystallizing Decoction at room temperature for 25-100° C. by methods such as mixing, heating, grinding, evaporation, ultrasound and microwave. DES, which are not present, become ready for use after being dried under vacuum for 24-72 hours at 40-70° C.

FIG. 1 shows the schematic of the process for using hydrophilic and hydrophobic DES as plasticizers in hydrophobic polymer substances in the wet technique, the schematic of which is given. According to this, method includes the following steps;
Weighing of the polymer substance (P), deep eutectic solution (DES) and solvent(S) in a glass container at a certain ratio (Polymer material (P)/Solvent(S) ratio: 1-30/100-mass/volume, DES/Polymer material (P) ratio: 1-50/100-mass/mass),
Polymer substances (P) are dissolved in the appropriate solvent(S) (such as xylene, toluene, benzene, dichloromethane, chloroform, carbon tetrachloride, tetrahydrofuran, dimethylformamide, dimethylsulfoxide, acetone, methanol) by mixing until a homogeneous mixture is formed (>25° C.) below the boiling temperature of the solvent (1-24 hours) and deep as a plasticizer the formation of a solution by adding a eutectic solution (1) occurs,
Performing the homogenization (2) process by mixing the polymer substance (P), solvent(S) and DES mixture below the boiling temperature of the solvent(S) (>25° C.) until a homogeneous mixture is formed (1-24 hours),
Ensuring gas removal by holding the resulting mixture (3),
Casting (4) process,
Solvent removal by keeping the solvent(S) at a minimum temperature of 25° C. for a maximum of 48 hours (5),
Peeling (6)

In the preferred configuration of the invention, the gas removal (3) process has been determined in such a way that there will be a maximum wait of 2 hours.

The preferred configuration of the invention is glass, metal or polytetrafluoroethylene (PTFE), the surface on which the casting (4) process is applied.

The dry method can also be used in the use of hydrophilic or hydrophobic DES in the plasticization of polymers. The dry method involves extrusion as shown in FIG. 2. The process steps for the dry method, which includes the extrusion process;
The addition of a deep eutectic solution from the hopper (7) in the form of plastic pellets together with polymer (8) and the interaction of screw pitches (12) located in the extrusion screw (9) in the barrel (11) by rotating and moving forward to be affected by the heat given by heaters (10),
The polymer compressed from the part of the shaping die (13) and subjected to the plasticization process comes out in a manner determined according to the structure of the extrudate (14),

In this study, hydrophilic deep eutectic solutions (HFDES) and hydrophobic deep eutectic solutions (HBDES) are prepared by hydrogen bond interaction of hydrogen bond acceptor (HBA) and hydrogen bond donor (HBD) substances. The HBA and HBDs used in the structure of the prepared DES are given in table 1. Before wet or dry plasticization processes, the selection of BHA and HBD can be selected in such a way as to ensure that the plastic material has the desired structure according to the area in which it will be used. Based on this, it is possible to determine the compounds that can be selected for the DES to be used in plasticization to show hydrophilic or hydrophobic properties.

TABLE 1

| | HBA | HBD |
|---|---|---|
| HFDES | Quaternary ammonium halogen; | Acids: Malonic, citric, benzoic, succinic, oxalic, |
| | Choline chloride | tartaric, acetic, fumaric, azelaic, adipic, levulinic |
| | | Nitrogenous compounds: Urea, acetamide, |
| | | triourea |
| | | Polyols: Glycerol, sorbitol, xylitol, maltitol, ethylene |
| | | glycol |
| | | Sugars: Fructose, glucose, lactose, sucrose |
| | | Phenols |
| HBDES | Quaternary ammonium halogen: | Fatty acids: Decanoic acid, octanoic acid, |
| | Choline chloride, | dodecanoic acid, hexanoic acid, myristic acid, |
| | Methyltrioctylammonium | palmitic acid, ricinoleic acid, nonanoic acid, |
| | chloride, Tetrabutylammonium | octadecanoic acid, oleic acid, butyric acid, valeric |
| | chloride, | acid, stearic acid |
| | Trimethylammonium chloride, | |
| | Tetrabutylammonium bromide, | |
| | Methyltrioctylammonium bromide, | |
| | Tetraheptilammonium chloride, | |
| | Tetraoctilammonium chloride, | |
| | Tetraoctylammonium bromide | |
| | Terpenes: Menthol, Thymol, | Acids: Acetic, levulinic, lactic, purivic acids, etc. |
| | Lidocaine, | Alcohols: n-butyl alcohol, 1-octanol, 1-dodecanol, |
| | Carvacrol, Coumarin, Campor | oleyl alcohol, |
| | | 1-propanol, 1-butanol, 1-hexanol, etc. |
| | Others: Atropine, Proline, Alanine, | Terpenes: Menthol, Thymol |
| | Lysine, Dodecanoic acid | Others: Phenol, Atropine, 1-tetradecanol, 1,2- |
| | | decandiol, 1- |
| | | naptol, proline, arginine, ethylene glycol, glycerol |

In the mixing process of the HBA and HBD substances mentioned in Table 1, individuals or combinations selected from a group consisting of acids, nitrogenous compounds, polyols, sugars and phenols are used to prepare hydrophilic DES with choline chloride, a quaternary ammonium halide, as an HBA substance and acids, nitrogenous compounds, polyols, sugars and phenols as an HBD substance. Likewise, to prepare hydrophobic DES (HBDES) in the mixing process of HBA and HBD substances mentioned in table 1, fatty acids, acids, terpenes, Phenol, Atropine, Atropine, Alanine, Lysine, dodecanoic acid with a selected component from the group containing Quaternary ammonium halides, terpenes, Atropine, 1-tetradecanol, 1,2-decandiol, 1-naptol as HDB substance with a component selected from the group containing HBA substance, Atropine, Phenol, Atropine, 1-tetradecanol, 1,2-decandiol, 1-naptol, individuals or combinations selected from the group containing proline, arginine, ethylene glycol, glycerol are used.

For an effective plasticization, the polarity of the plasticizer is decided by taking into account various parameters such as hydrogen bond structure, dielectric constant, thermal strength, volatility and Decolonization, as well as compatibility between the polymer. The fact that DESS have similar chemical structures, thermal strengths, polarity and volatility to conventional plasticizers also indicates that they will cause them to exhibit similar behavior in polymers.

### Sample;

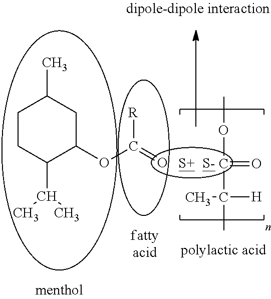

The theoretical approach that polylactic acid, a hydrophobic polymer, and hydrophobic Dec (synthesized from menthol and fatty acid) will behave like conventional plasticizers is shown thanks to the dipole-dipole van der walls interaction image that will be formed between the carbonyl groups.

1. A hydrophilic/hydrophobic deep eutectic solution production method for use in the plasticization of polymers comprising the following processing steps before dry or wet plasticization method steps:
a) mixing of hydrogen bond acceptor substance (HBA) and hydrogen bond donor substance (HBD) at a temperature of 25° C.-100° C. for 1-24 hours so that the HBA/HBD molar concentrations are in the ratio of 1-5/1-8,
b) control of crystallization by keeping at room temperature for 24-72 hours,
c) drying of deep eutectic solutions (DES) without crystallization for 24-72 hours at a temperature of 40° C.-70° C.

2. The method of claim 1, where process step (a) includes one of the individuals or combinations selected from the group consisting of grinding, evaporation, freeze drying, extrusion, ultrasound and microwave processes along with the mentioned mixing process.

3. The method of claim 1, wherein the HBA is choline chloride.

4. The method of claim 1, wherein the mentioned HBD is an individual or combinations selected from a group consisting of acids, nitrogenous compounds, polyols, sugars and phenols.

5. The production method of claim 1, wherein the solution obtained is hydrophilic deep eutectic solution (HFDES).

6. The method of claim 1, wherein the HBA is selected from a group consisting of quaternary ammonium halides, terpenes, Atropine, Proline, Alanine, Lysine, dodecanoic acid.

7. The method of claim 1, wherein the HBD is an individual or combinations selected from a group consisting of fatty acids, acids, terpenes, Phenol, Atropine, 1-tetradecanol, 1,2-decandiol, 1-naptol, proline, arginine, ethylene glycol, glycerol.

8. The method of claim 1, wherein the solution obtained is a hydrophobic deep eutetic solution (HBDES).

9. The method of claim 1, wherein the wet plasticization method includes the steps of:
a) weighing polymer substance (P), deep eutectic solution (DES) and solvent(S) in a glass container in a ratio of: Polymer material (P) I Solvent(S) ratio: 1-30/100-mass/volume and DES/Polymer material (P) ratio: 1-50/100-mass/mass,
b) dissolving the polymer substances (P) in an appropriate solvent(S) by mixing for 1-24 hours until a homogeneous mixture is formed at a temperature lower than 25° C., so that the boiling point of the solvent is below, and the formation of a solution by adding a deep eutectic solution (DES) as a plasticizer (1) occurs,
c) performing the homogenization (2) process by mixing the polymer substance (P), solvent(S) and DES mixture for 1-24 hours until a homogeneous mixture is formed at a temperature of 25° C., so that the boiling point of the solvent(S) is below the boiling point of the solvent(S),
d) providing gas removal by keeping the mixture (3) formed,
e) casting (4) process,
f) solvent removal (5) by keeping the solvent(S) at a minimum temperature of 25° C. for a maximum of 48 hours,
g) peeling (6).

10. The method of claim 9, wherein the solvent(S) mentioned is xylene, toluene, benzene, dichloromethane, chloroform, carbon tetrachloride, tetrahydrofuran, dimethylformamide, dimethylsulfoxide, acetone or methanol.

11. The method of claim 9, wherein the application of the casting (4) process mentioned in the (e) process step to a glass, metal or polytetrafluoroethylene (PTFE) surface.

12. The method of claim 1, wherein the dry plasticization method comprises:
mechanical mixing of polymers with deep eutectic solutions at DES/Polymer: 1-50/100-mass/mass ratio, at a temperature of 25° C. and in a period of 1-60 minutes,
interaction of the prepared mixture with each other by adding from the hopper (7), rotating the screw pitches (12) steps located on the extrusion screw (9) in the barrel (11), moving forward to be affected by the heat given by the heaters (10) by the rotation of the screw pitches (12),
the polymer compressed from the part of the shaping die (13) and subjected to the plasticization process comes out in a manner determined according to the structure of the extrudate (14).

13. A plastic material of polymer which is produced by a method according to claim 1.
